(19) United States
(12) Patent Application Publication
(10) Pub. No.: US 2008/0148649 A1
(43) Pub. Date: Jun. 26, 2008

(54) Ruthenium-barrier polishing slurry

(76) Inventor: Zhendong Liu, Newark, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/644,370

(22) Filed: Dec. 21, 2006

(51) Int. Cl. C09K 3/14; B24B 17/00

(52) U.S. Cl. 51/298; 451/36

(57) ABSTRACT

The polishing slurry is useful for removing ruthenium layers from patterned semiconductor substrates in the presence of at least one nonferrous interconnect metal and a dielectric. The polishing slurry includes 0.001 to 10 weight percent periodic acid or salt, at least 0.0001 weight percent inhibitor for reducing removal rate of the nonferrous interconnect metals, 0.00001 to 5 weight percent organic additive for reducing dielectric removal rate, the organic additive being selected from at least one of water soluble polymers and surfactants, the organic additive containing an ethylene oxide group or an amide group, 0.1 to 50 weight percent abrasive and balance water; and the slurry having a pH of greater than 8 to 12.

### BACKGROUND OF THE INVENTION

The invention relates to chemical mechanical planarizing (CMP) formulations for removing ruthenium metal layers and, more particularly, to polishing compositions for selectively removing ruthenium metal layers in the presence of interconnect structures of integrated circuit devices.

In recent years, the semiconductor industry has increasingly relied upon copper electrical interconnects in forming integrated circuits. The copper interconnect layers typically include a first copper seed layer sputtered and a second layer electrodeposited on the sputter layer to fill trenches that form the interconnects. As interconnect layers become increasingly small, the copper seed layer becomes too thick for commercial practicality. In response to this problem, semiconductor fabricators are increasingly using a ruthenium seed layer deposited by atomic layer deposition or chemical vapor deposition (CVD). These processes provide the advantage of producing a thin-uniform ruthenium film suitable for copper electrodeposition of small-scale interconnects.

A barrier layer protects dielectrics from poisoning that can arise from copper diffusing from the interconnects. Proposed barrier materials include, tantalum, tantalum nitride, tantalum-silicon nitrides, titanium, titanium nitrides, titanium-silicon nitrides, titanium-titanium nitrides, titanium-tungsten, tungsten, tungsten nitrides and tungsten-silicon nitrides. Since ruthenium seed layers typically provide an inadequate diffusion barrier for copper interconnects, integration schemes rely upon a barrier material between the ruthenium and the dielectric. This barrier layer protects the dielectric from copper diffusing through the ruthenium into the dielectric layer. The most common barrier materials used today are tantalum and tantalum nitride barriers.

In response to increasing demands for high density integrated circuits, semiconductor producers now fabricate integrated circuits containing multiple overlying layers of metal interconnect structures. During device fabrication, planarizing each interconnect layer improves packing density, process uniformity, product quality and most importantly, enables manufacturing of multiple layer integrated circuits. Semiconductor producers rely upon chemical-mechanical-planarizing (CMP) as a cost effective means of producing flat substrate surfaces. The CMP process is typically carried out in a two-step sequence. First, the polishing process uses a “first-step” slurry specifically designed to rapidly remove copper. After the initial copper removal, a “second-step” slurry removes the ruthenium layer with the barrier material.

Ruthenium polishing slurries have been proposed for various applications, including logic and memory chip wafers. For example, Yun et al., in U.S. patent Pub. No. 2006/0037942, disclose a periodic acid-containing slurry for removing ruthenium layers with high ruthenium to TEOS dielectric selectivity for polishing capacitors for memory chip applications. These periodic acid-containing slurries tend to operate at acidic pH levels. Similar to the slurry of Yun et al., typical second-step ruthenium slurries require excellent selectivity to remove the barrier material without adversely impacting the dielectric or electrical properties of the interconnect structure.

Because integration schemes used by different IC manufacturers vary; the rate selectivity required for the various films polished in the barrier CMP step also varies. Certain film stacks require higher copper, TEOS (hardmask) and CDO rates for topography correction; but on other occasions, low copper, TEOS and CDO are useful. A barrier removal slurry that can remove ruthenium layers, and correct profiles for copper, TEOS and CDO facilitates further decreases in line width.

In view of the above, there exists a need to provide a second-step ruthenium slurry that possesses a high removal rate of ruthenium and barrier layers, excellent selectivity to interconnect metals, controlled removal of TEOS, CDO and copper removal rates.

### STATEMENT OF THE INVENTION

In one aspect of the invention, a polishing slurry is useful for removing ruthenium layers from patterned semiconductor substrates in the presence of at least one nonferrous interconnect metal and a dielectric comprising: 0.001 to 10 weight percent periodic acid or salt, at least 0.0001 weight percent inhibitor for reducing removal rate of the nonferrous interconnect metals, 0.00001 to 5 weight percent organic additive for reducing dielectric removal rate, the organic additive being selected from at least one of water soluble polymers and surfactants, the organic additive containing an ethylene oxide group or an amide group, 0.1 to 50 weight percent abrasive and balance water; and the slurry having a pH of greater than 8 to 12.

In another aspect of the invention, a polishing slurry is useful for removing ruthenium layers from patterned semiconductor substrates in the presence of at least one nonferrous interconnect metal and a dielectric comprising: 0.005 to 5 weight percent periodic acid or salt, at least 0.001 weight percent inhibitor for reducing removal rate of the nonferrous interconnect metals, 0.0001 to 2 weight percent organic additive for reducing dielectric removal rate, the organic additive being selected from at least one of water soluble polymers and surfactants, the organic additive containing an ethylene oxide group or an amide group, 0.2 to 40 weight percent abrasive and balance water; and the slurry having a pH of 8.2 to 11.

In another aspect, invention provides a method of polishing a patterned semiconductor substrate, the patterned semiconductor substrate including a ruthenium layer in the presence of at least one nonferrous interconnect metal and a dielectric including the step of: polishing the patterned semiconductor substrate with a polishing slurry and a polishing pad to remove at least a portion of the ruthenium layer, the polishing slurry comprising: 0.001 to 10 weight percent periodic acid or salt, at least 0.0001 weight percent inhibitor for reducing removal rate of the nonferrous interconnect metals, 0.00001 to 5 weight percent organic additive for reducing dielectric removal rate, the organic additive being selected from at least one of water soluble polymers and surfactants, the organic additive containing an ethylene oxide group or an amide group, 0.1 to 50 weight percent abrasive and balance water; and the slurry having a pH of greater than 8 to 12.

### DETAILED DESCRIPTION

It has been discovered that periodic acid at an alkaline pH and certain organic additives is effective at removing ruthenium layers without excessive erosion of low-k or ultra-low-k dielectrics, such as CDO (carbon-doped oxides). In particular, the periodic acid facilitates ruthenium removal at pH levels above 8. Furthermore, specific water soluble polymers and surfactants act to protect low-k dielectrics from excessive erosion during the ruthenium polishing process. Specifically, the slurry is useful at removing the ruthenium layers that can also separate a barrier or dielectric layer from a non-ferrous metal interconnect. For purposes of the specification, the ruthenium layer typically coats a barrier layer and act as a seed layer for a non-ferrous interconnect, such as copper or copper alloy; and alternatively, it can provide direct or indirect separation between the dielectric and interconnect layers and optionally, one or more additional layers. For example ruthenium may separate a low-k dielectric's hard mask layer, such as TEOS from a copper interconnect layer.

Periodic acid at alkaline pH levels is particularly effective at removing ruthenium layers. For purposes of this specification ruthenium layers include commercially pure ruthenium and ruthenium-base alloys of ruthenium. For example, 0.001 to 10 weight percent periodic acid or salt can accelerate ruthenium barrier layer polishing. Unless specifically expressed otherwise, this specification defines all slurry ingredients in terms of weight percent. Preferably, the slurry contains 0.005 to 5 weight percent periodic acid or salt; and most preferably 0.01 to 3 weight percent periodic acid or salt. Typically, periodate salts added are sodium, potassium and ammonium periodates. And potassium periodate represents the most preferred salt. This oxidizer is particularly effective at a pH greater than 8 to 12. Preferably the slurry has a pH of 8.2 to 11; and most preferably of 8.5 to 10.5.

The slurry includes an organic additive as a rate control agent to limit dielectric erosion. The organic additive may be at least one of water soluble polymers and surfactants containing either an ethylene oxide group or an amide group. For example, 0.00001 to 5 weight percent organic additive is effective at limiting dielectric erosion; and in particular, the range is effective at limiting erosion for low-k and ultra-low-k dielectrics. Preferably, the slurry includes 0.0001 to 2 weight percent organic additive and most preferably, 0.001 to 1 weight percent organic additive.

Examples of suitable surfactants containing an ethylene oxide group include at least one selected from the following: fatty alcohol polyglycol ether sulfate, ethoxylated fatty alcohol, ethoxylated alcohol phosphate ester, laureth sulfate salt, polyethyleneglycol ether, poly(ethylene glycol) laurate, poly(ethylene glycol) cocoamine, polyoxyethylene oleyl amine, polyethyleneglycol amine of hydrogenated tallow, non-ionic polyoxyethylene, polyoxypropylene block polymers non-ionic ethoxylated alkyl phenols and derivatives of the foregoing. Examples of suitable surfactants containing an amide group include at least one selected from the following: ethanolamides of coconut acid, fatty alcohol alkanolamide, cocoamide, coconut acid monoethanolamide, N,N-bis(2-hydroxyethyl)dodecanamide, polyoxyalkylene amide ester, alkyl amide propyl dimethyl glycine, sulfated fatty acid amide, amide ethoxylate, amide sulfonate, stearamide, polyolefin amide alkeneamine, oleic acid amide ethoxylate, alkylamide, polyalkoxylated amide, stearamidopropyl dimethylamine, polyisobutylenesuccinate amide, polyester amide, behenamidopropyl dimethylamine, lauroamidopropyl dimethylamine, distearyl phthalic acid amide, behenic acid amide, behenic acid diethanolamineamide, behenic acid monoethanolamineamide and derivatives of the foregoing.

In addition, water soluble polymers containing an ethylene oxide or amide group have proven effective for reducing dielectric removal rates, such as CDO. The water soluble polymer typically has a weight average molecular weight between 500 and 1,000,000. For purposes of this specification, molecular weight represents weight average molecular weight as determined by gel permeation chromatography. Preferably, the water soluble polymer has a weight average molecular weight between 1,000 and 500,000. Examples of useful water soluble polymers include at least one selected from the following: polyvinylpyrrolidone, poly(ethylene oxide), poly(ethylene glycol), poly(ethylene glycol)acrylate, poly(ethylene glycol)n-alkyl 3 sulfopropyl ether, poly(ethylene glycol)behenyl ether methacrylate, poly(ethylene glycol)-co-4 benzyloxybenzyl alcohol, poly(ethylene glycol)bis(3-aminopropyl) terminated, poly(ethylene glycol)bis(carboxymethyl)ether, poly(ethylene glycol)bis(2-ethylhexanoate), Poly(ethylene glycol)butyl ether, poly(ethylene glycol)diacrylate, poly(ethylene glycol)dibenzoate, poly(ethylene glycol)dimethyl ether, poly(ethylene glycol)methyl ether, poly(ethylene glycol)dimethyl ether methacrylate, poly(ethylene glycol)dioleate, poly(ethylene glycol)monooleate, poly(ethylene glycol)phenyl ether acrylate, poly(ethylene glycol)4-nonylphenyl 3-sulfopropyl ether, poly(ethylene glycol)divinyl ether, poly(propylene glycol), dimethylsiloxane/ethylene oxide copolymers, poly(ethylene glycol-block-propylene glycol), poly(ethylene glycol-block-propylene glycol-block-ethylene glycol), poly(ethylene glycol) tetrahydrofurfuryl ether, polyvinyl alcohol, poly(vinyl alcohol-co-ethylene), poly(ethylene adipate), polyacrylamide, poly(acrylamide-co-acrylic acid), poly(acrylamide-co-diallyldimethylammonium chloride), poly(2-acrylamido-2-methyl-1-propanesulfonic acid), poly(2-acrylamido-2-methyl-1-propanesulfonic acid-co-acrylonitrile), poly(2-acrylamido-2-methyl-1-propanesulfonic acid-co-styrene), poly(1-vinylpyrrolidone-co-2-dimethylaminoethyl methacrylate), polyvinylpyrrolidone-iodine complex, poly(1-vinylpyrrolidone-co-styrene), poly(1-vinylpyrrolidone-co-vinyl acetate) and derivatives of the foregoing. Polyvinylpyrrolidone has proven an effective water soluble polymer for protecting low-k and ultra-low-k dielectrics.

The slurry optionally contains 0 to 2 weight percent complexing agent for the nonferrous metal. Preferably, the slurry contains 0.0001 to 2 weight percent complexing agent for the nonferrous metal; and most preferably, the slurry contains 0.001 to 1 weight percent complexing agent. Typical complexing agents include at least one of carboxylic acids, multi-carboxylic acids, aminocarboxylic acids, multi-amine compounds and mixtures thereof. Specific complexing agents include at least one selected from the following: acetic acid, alanine, aspartic acid, ethyl acetoacetate, ethylene diamine, trimethylene diamine, ethylenediaminetetraacetic acid (EDTA), citric acid, lactic acid, malic acid, maleic acid, malonic acid, oxalic acid, triethylenetetramine, diethylene triamine, glycine, glycolic acid, gluteric acid, salicylic acid, nitrilotriacetic acid, ethylenediamine, hydroxyethylenethylenediaminetetraacetic acid, hydroxyquinoline, tartaric acid, sodium diethyl dithiocarbamate, succinic acid, sulfosalicylic acid, triglycolic acid thioglycolic acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, gallic acid, tannic acid, salts thereof and mixtures thereof. Some organic acids, such as citric acid may serve as both a complexing agent and a pH adjusting agent. The complexing agent also provides the advantage of controlling the discoloration of the polishing slurry during aging. Adding the complexing agent accelerates copper removal, but excessive complexing agent can adversely impact polishing rate.

An optional amount of 10 parts per billion (ppb) to 4 weight percent complexing agent can control the discoloration of the polishing slurry. Insufficient complexing agent can result in unstable polishing slurries (polishing slurries that undergo a color change within too short a time period); and excessive complexing agent can adversely impact polishing rate. EDTA represents the most effective complexing agent for controlling color change of the slurry.

The ruthenium polishing composition includes an abrasive for “mechanical” removal of the barrier material. The CMP composition includes an abrasive for assisting with “mechanical” removal of ruthenium and barrier layers. The abrasive is preferably a colloidal abrasive. Example abrasives include the following: inorganic oxide, metal boride, metal carbide, metal hydroxide, metal nitride, or a combination comprising at least one of the foregoing abrasives. Suitable inorganic oxides include, for example, silica (SiO₂), alumina (Al₂O₃), zirconia (ZrO₂), ceria (CeO₂), manganese oxide (MnO₂), and mixtures thereof. Alumina is available in many forms such as alpha-alumina, gamma-alumina, delta-alumina, and amorphous (non-crystalline) alumina. Other suitable examples of alumina are boehmite (AlO(OH)) particles and mixtures thereof. Modified forms of these inorganic oxides such as polymer-coated inorganic oxide particles may also be utilized if desired. Suitable metal carbides, boride and nitrides include, for example, silicon carbide, silicon nitride, silicon carbonitride (SiCN), boron carbide, tungsten carbide, zirconium carbide, aluminum boride, tantalum carbide, titanium carbide, and mixtures comprising at least one of the foregoing metal carbides, boride and nitrides. Diamond may also be utilized as an abrasive if desired. Alternative abrasives also include polymeric particles and coated polymeric particles. The preferred abrasive is silica.

The abrasive has a concentration in the aqueous phase of the polishing composition of 0.1 to 50 weight percent. Preferably, the abrasive concentration is 0.2 to 40 weight percent. And most preferably, the abrasive concentration is 1 to 30 weight percent. Typically, increasing abrasive concentration increases the removal rate of dielectric materials; and it especially increases the removal rate of low-k dielectric materials, such as carbon-doped oxide. For example, if a semiconductor manufacturer desires an increased low-k dielectric removal rate, then increasing the abrasive content can increase the dielectric removal rate to the desired level.

The abrasive preferably has an average particle size of less than 250 nm for preventing excessive metal dishing and dielectric erosion. For purposes of this specification, particle size refers to the colloidal silica's average particle size. Most preferably, the silica has an average particle size of less than 100 nm to further reduce metal dishing and dielectric erosion. In particular, an average abrasive particle size less than 75 nm removes the ruthenium barrier metal at an acceptable rate without excessive removal of the dielectric material. For example, the least dielectric erosion and metal dishing occur with a colloidal silica having an average particle size is 20 to 80 nm. In addition, the preferred colloidal silica may include additives, such as dispersants to improve the stability of the silica. One such abrasive is colloidal silica that is available from AZ Electronic Materials, of Puteaux, France.

In addition, high purity silica particles also serve to decrease the aging or yellowing rate of the polishing slurries. For example maintaining total transition metal concentration to less than 1 part per million (ppm) further increases the slurry's ability to decrease yellowing. Furthermore, limiting potassium and sodium to less than 1 ppm reduces adverse diffusion of these detrimental components into dielectric layers.

Optionally, the removal rate of barrier layers, such as tantalum, tantalum nitride, titanium and titanium nitride is preferably optimized by the use of an additional or supplemental oxidizing agent. Suitable oxidizers include, for example, hydrogen peroxide, monopersulfates, iodates, magnesium perphthalate, peracetic acid and other peracids, persulfates, bromates, nitrates, iron salts, cerium salts, manganese (Mn) (E), Mn (IV) and Mn (VI) salts, silver salts, copper salts, chromium salts, cobalt salts, halogens, hypochlorites, or combinations comprising at least one of the foregoing oxidizers. The preferred oxidizer is hydrogen peroxide. It is to be noted that the oxidizer is typically added to the polishing composition just prior to use and in these instances the oxidizer is contained in a separate package. Adjusting the amount of oxidizer, such as peroxide can also control the metal interconnect removal rate. For example, increasing the peroxide concentration increases the copper removal rate. Excessive increases in oxidizer, however, provide an adverse impact upon polishing rate.

Additionally, the slurry contains at least 0.0001 weight percent inhibitor to control nonferrous interconnect removal rate by static etch or other removal mechanism. Adjusting the concentration of an inhibitor adjusts the nonferrous interconnect metal removal rate by protecting the metal from static etch. Preferably, the slurry contains 0.0001 to 10 weight percent inhibitor for inhibiting static etch of nonferrous metal, for example, copper interconnects. Most preferably, the slurry contains 0.05 to 2 weight percent inhibitor. The inhibitor may consist of a mixture of inhibitors. Azole inhibitors are particularly effective for copper and silver interconnects. Typical azole inhibitors include benzotriazole (BTA), mercaptobenzothiazole (MBT), tolytriazole and imidazole. BTA is a particularly effective inhibitor for copper and silver interconnects.

Optionally, the slurry may contain leveling agents such as chlorides. For example, ammonium chloride provides an improvement in wafer surface appearance.

Optionally, the polishing composition includes an inorganic pH adjusting agent to increase the pH of the polishing composition to a level of at least 8 with a balance water. Preferably, the pH adjusting agent only contains an impurity level concentration of metallic ions. In addition, the slurry most preferably relies upon a balance of deionized water to limit incidental impurities. The pH adjusting agent can be either an organic or inorganic acid or bases. Preferably, the pH adjusting agent is an inorganic acid or base, such as phosphoric acid or potassium hydroxide.

The slurry enables the CMP apparatus to operate with a low pad pressure, for example at 7.5 to 25 kPa and, in certain cases, even below 7.5 kPa. The low CMP pad pressure improves polishing performance by reducing scratching and other undesired polish defects and decreases damage to fragile materials. For example, low dielectric constant materials fracture and delaminate, if exposed to high compressive forces. Furthermore, the barrier metal removal rate obtained with the alkaline polishing slurry enables effective barrier metal polishing at these low pressures.

For purposes of this specification, useful for preferentially removing barrier materials in the presence of nonferrous interconnect metals refers to removing the ruthenium and barrier layers at a rate, as expressed in Angstroms per minute, of at least equal to or greater than fifty percent of the removal rate of the dielectric layer at a downforce less than 25 kPa. For purposes of this specification, ruthenium and barrier layer selectivity refers to each of the ruthenium and barrier layer having the required selectivity. Typically, the polishing slurry has a ruthenium and barrier to copper selectivity of at least 0.2 to 1 as measured with a polishing pad pressure measured normal to a wafer less than 25 kPa. Preferably, the polishing slurry has a ruthenium and barrier to copper selectivity of at least 0.5 to 1 as measured with a polishing pad pressure measured normal to a wafer less than 25 kPa. Most preferably, the polishing slurry has a ruthenium and barrier to copper selectivity of at least 1 to 1. A specific example for testing the selectivity is the conditions, including the polyurethane polishing pad, of Example 1. This high level of selectivity allows a chip manufacturer to remove the ruthenium layer or joint ruthenium and barrier layers without removing excess dielectric or interconnect material. For purposes of this specification, limited dielectric erosion refers to a chemical mechanical polishing process where after polishing, the dielectric has sufficient thickness to act on behalf of its intended purpose.

The polishing composition can also optionally include buffering agents. The polishing composition can further optionally include defoaming agents, such as non-ionic surfactants including esters, ethylene oxides, alcohols, ethoxylate, silicon compounds, fluorine compounds, ethers, glycosides and their derivatives, and the like. The defoaming agent can also be an amphoteric surfactant. The polishing composition may optionally contain biocides, such as Kathon® ICP III, containing active ingredients of 2-methyl-4-isothiazolin-3-one and 5-chloro-2-methyl-4-isothiazolin-3-one (Kathon is a registered trademark of Rohm and Haas Company).

### EXAMPLES

A list of slurry compositions were prepared to evaluate the polishing performance on polishing ruthenium barriers. In the preparation of the compositions, the requisite amounts of all required chemicals as shown (with the exception of the oxidizer and the abrasive) were added to deionized water in a container. The slurry in the container was stirred until all the ingredients were completely dissolved. The next step was adjusting the slurry's pH to approximately match that of the abrasive raw material. The abrasive was then added to the container. The pH of the mixture was then adjusted to an intermediate value—the pH was adjusted by the addition of phosphoric acid or potassium hydroxide. Finally, the oxidizer was added to the container with the slurry's pH value changing from the intermediate value to the final targeted value. For purposes of this specification, letters represent comparative examples and numbers represent examples of the invention.

The polishing was performed using a Mirra® model polishing tool manufactured by Applied Materials. The polishing pad was a Politex™ High E porous polyurethane pad supplied by Rohm and Haas Electronic Materials CMP Technologies, unless otherwise indicated. The polishing process was performed at a membrane pressure of 10.3 kPa (1.5 psi), a table speed of 93 revolutions per minute (rpm) and a carrier speed of 87 rpm. The polishing composition supply rate was 200 ml/min. 200 mm blanket wafers were from ATDF, Inc. Copper, tantalum nitride and ruthenium removal rates (RR) were measured on a Four-Point Probe CDE Resmap. TEOS and Coral® carbon-doped oxide (CDO) film removal rates were measured by a ThermaWave Optiprobe® 2600 metrology tool. All removal rates shown are in Angstroms/min.

### Example 1

This example shows the effect of pH on the removal rate of ruthenium and other films. Table 1 lists the slurry compositions. Table 2 lists the removal rate corresponding to these compositions.

TABLE 1

| | BTA, | EDTA, | Periodic acid, | Klebsol 1501-50, | |
|---|---|---|---|---|---|
| Slurries | wt % | wt % | wt % | wt % | pH |
| A | 0.1 | 0.00384 | 0.5 | 10 | 2.8 |
| B | 0.1 | 0.00384 | 0.5 | 10 | 4 |
| 1 | 0.1 | 0.00384 | 0.5 | 10 | 9 |
| 2 | 0.1 | 0.00384 | 0.5 | 10 | 10 |
| 3 | 0.1 | 0.00384 | 0.5 | 10 | 11 |

BTA represents benzotriazole.
Klebosol 1501-50 is a colloidal silica abrasive with an average particle size of 50 nm, from AZEM.
EDTA represents ethylenediaminetetraacetic acid.

TABLE 2

| | Ru RR | Cu RR | TaN RR | TEOS RR | CDO RR |
|---|---|---|---|---|---|
| Slurries | (Å/min.) | (Å/min.) | (Å/min.) | (Å/min.) | (Å/min.) |
| A | 118 | 1949 | 324 | 367 | 307 |
| B | 97 | 1514 | 278 | 297 | 260 |
| 1 | 354 | 219 | 300 | 568 | 722 |
| 2 | 251 | 251 | 441 | 561 | 860 |
| 3 | 240 | 371 | 511 | 559 | 825 |

Based on the above data, it was determined that alkaline pH provided higher Ru removal rates and much lower Cu removal rates than that achieved at acidic pH levels.

### Example 2

This example examines the effect of surfactants with ethylene oxide groups (—CH₂—CH₂—O—) on film removal rates. All formulations in Table 3 (slurries 4-12) are based on slurry 1. In addition to the chemical additives listed in the table, the slurries also contain the same amounts of BTA, EDTA, Periodic acid, PL1501-50, and has the same pH as slurry 1. The molecular formulas of these surfactants are listed in Table 4. It can be seen that all surfactants have ethylene oxide groups (—CH₂—CH₂—O—).

TABLE 3

| | Disponil | | | | Tergitol | |
|---|---|---|---|---|---|---|
| | FES 32 IS, | Brij 35 | ChemEEN | Pluronic | NP-9, | |
| Slurries | (wt %) | (wt %) | T-5 (wt %) | L31(wt %) | (wt %) | pH |
| 4 | 0.001 | | | | | 9 |
| 5 | | 0.01 | | | | 9 |
| 6 | | 0.05 | | | | 9 |
| 7 | | | 0.02 | | | 9 |
| 8 | | | 0.1 | | | 9 |
| 9 | | | | 0.02 | | 9 |
| 10 | | | | 0.1 | | 9 |
| 11 | | | | | 0.05 | 9 |
| 12 | | | | | 0.2 | 9 |

Disponil PBS 32IS is a fatty alcohol polyglycol ether sulfate from Cognis Corporation.
Brij 35 is a polyethylene glycol ether of lauryl alcohol from Uniqema.
ChemEEN T-5 is a polyethylene glycol amine of hydrogenated tallow from Chemax Inc.
Pluronic L31 is a polyoxyethylene, polyoxypropylene block polymer from BASF
Tergitol NP-9 is a ethoxylated alkyl phenol from Dow Inc.

TABLE 4

| Slurries | Molecular Formula |
|---|---|
| Disponil FES 32 IS | R(CH₂CH₂O)₃₃SO₃Na, R is a fatty alcohol |
| Brij 35 | CH₃(CH₂)₁₀CH₂(OCH₂CH₂)ₙOH, average n = 23 |
| ChemEEN T-5 | R—N(CH₂CH₂O)ₓH(CH₂CH₂O)_{y}H, R represents |
| | alkyl groups from hydrogenated tallow, |
| | average (x + y) = 5 |
| Pluronic L31 | HO(CH₂CH₂O)ₓ(CH(CH₃)CH₂O)_{y}(CH₂CH₂O)_{z}H, |
| | average x = 2, y = 16, z = 2 |
| Tergitol NP-9 | C₉H₁₉C₆H₄(OCH₂CH₂)ₙOH, average n = 9 |

### Table 5 provides the film removal rates for the slurries of Tables 3 and 4.

TABLE 5

| | Ru RR | Cu RR | TaN RR | TEOS RR | CDO RR |
|---|---|---|---|---|---|
| Slurries | (Å/min.) | (Å/min.) | (Å/min.) | (Å/min.) | (Å/min.) |
| 1 | 354 | 219 | 300 | 568 | 722 |
| 4 | 262 | 42 | 348 | 620 | 78 |
| 5 | 397 | 147 | 286 | 486 | 8 |
| 6 | 428 | 124 | 168 | 318 | 0 |
| 7 | 266 | 169 | 282 | 381 | 76 |
| 8 | 302 | 148 | 115 | 185 | 18 |
| 9 | 335 | 88 | 316 | 458 | 65 |
| 10 | 306 | 106 | 298 | 459 | 33 |
| 11 | 231 | 200 | 223 | 399 | 22 |
| 12 | 273 | 111 | 113 | 164 | 14 |

Table 5 indicates that all these surfactants containing ethylene oxide groups (—CH₂—CH₂—O—) were able to effectively decrease CDO removal rate and maintain sufficiently high ruthenium removal rate.

### Example 3

This example examines the effect of some chemical additives with amide groups on the film removal rate. The general formula for the amide functional group has the following form:

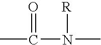

R is hydrogen or an organic radical.

Two chemical additives are shown in this example. One is a surfactant named Incromide CA. It is an ethanolamide of coconut acid from Croda Inc. It has a general formula of RCO—N(CH₂CH₂OH)₂. Table 6 lists the slurry compositions (slurries 13-15) containing Incromide CA. These formulations are all based on slurry 1. In addition to Incromide CA listed in the table, these slurries also contained the same amounts of BTA, EDTA, Periodic acid, PL1501-50, and has the same pH as slurry 1.

The other organic chemical additive in this example was polyvinylpyrrolidone (PVP). The formulation containing PVP (slurry 16) is listed in Table 7. PVP is a polymer with the following structure:

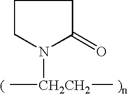

TABLE 6

| | Incromide CA | |
|---|---|---|
| Slurries | (wt %) | pH |
| 13 | 0.02 | 9 |
| 14 | 0.05 | 9 |
| 15 | 0.1 | 9 |

TABLE 7

| | | | Periodic | | | | Klebsol | |
|---|---|---|---|---|---|---|---|---|
| | | CA, | acid | PVP | NH₄Cl | H₃PO₄ | 1501-50 | |
| Slurry | BTA (wt %) | (wt %) | (wt %) | (wt %) | (wt %) | (wt %) | (wt %) | pH |
| 16 | 0.02 | 0.3 | 0.5 | 0.4 | 0.01 | 0.1 | 14 | 10.5 |

CA represents citric acid. The PVP used in this example had a gel permeation chromotography molecular weight of 10,000.

### Table 8 provides the film removal rates for the slurries of Tables 7 and 8.

TABLE 8

| | Ru RR | Cu RR | TaN RR | TEOS RR | CDO RR |
|---|---|---|---|---|---|
| Slurries | (Å/min.) | (Å/min.) | (Å/min.) | (Å/min.) | (Å/min.) |
| 1 | 354 | 219 | 300 | 568 | 722 |
| 13 | 283 | 273 | 401 | 662 | 246 |
| 14 | 250 | 265 | 372 | 622 | 204 |
| 15 | 294 | 191 | 405 | 650 | 198 |
| 16 | 333 | 610 | 372 | 476 | 40 |

Slurry 16 polishing data were obtained on an IC1010 ™ polyurethane polishing pad manufactured by Rohm and Haas Electronic Materials, CMP Technologies.

The polish data of Table 8 illustrate that the amide-containing chemicals, such as Incromide C A surfactant and water soluble PVP effectively reduced CDO removal rate, while maintaining a sufficient ruthenium removal rate.

### Example 4

This example examines the effects of Acumer 5000 and sodium dodecylsulfate on the polishing performance. Acumer 5000 is a common aqueous polyacrylic acid polymer made by Rohm and Haas Inc. It has a molecular structure below.

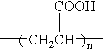

Sodium dodecylsulfate is a common anionic surfactant from Aldrich. It has a molecular formula C₁₂H₂₅SO₄Na. As can be seen, Acumer 5000 and sodium dodecylsulfate have neither an ethylene oxide group nor an amide group.

Table 9 lists the slurry composition. All formulations in Table 9 (slurries C, D, E) are based on slurry 1. In addition to the chemical additives in the table, the slurries also contain the same amounts of BTA, EDTA, Periodic acid, PL1501-50, and has the same pH as slurry 1. Table 10 lists the corresponding polishing data.

TABLE 9

| | Acumer 5000, | Sodium dodecylsulfate, | |
|---|---|---|---|
| Slurry | wt % | wt. % | pH |
| C | 0.3 | | 9 |
| D | | 0.002 | 9 |
| E | | 0.01 | 9 |

TABLE 10

| | Ru RR | Cu RR | TaN RR | TEOS RR | CDO RR |
|---|---|---|---|---|---|
| Slurry | (Å/min.) | (Å/min.) | (Å/min.) | (Å/min.) | (Å/min.) |
| 1 | 354 | 219 | 300 | 568 | 722 |
| C | 234 | 148 | 986 | 451 | 716 |
| D | 128 | 138 | 272 | 431 | 500 |
| E | 104 | 103 | 234 | 399 | 358 |

The polishing data of slurries D and E were obtained on an IC1010 ™ polyurethane polishing pad manufactured by Rohm and Haas Electronic Materials, CMP Technologies.

The polishing data indicated that the chemicals without an amide or ethylene group (such as Acumer 5000 and sodium dodecylsulfate) were ineffective at reducing CDO removal rate. Sodium dodecylsulfate had little effect in decreasing CDO removal rates, but it caused large detrimental drop in Ru removal rates.

### Example 5

This example examines the effect of oxidizers on ruthenium removal rate. Table 11 lists the slurry compositions. These compositions were based on slurry 16, with varying oxidizer concentrations. Table 12 illustrates the corresponding polishing data. The polishing test was conducted on an IC1010™ polyurethane polishing pad from Rohm and Haas Electronic Materials CMP Technologies.

TABLE 11

| | | | | | | | | Klebsol | |
|---|---|---|---|---|---|---|---|---|---|
| | | Citric | Periodic | | | | | 1501-50 | |
| | | acid | acid | H₂O₂ | PVP | NH₄Cl | H₃PO₄ | Silica | |
| Slurry | BTA wt % | wt % | wt % | wt % | wt % | wt % | wt % | wt % | pH |
| 16 | 0.02 | 0.3 | 0.5 | | 0.4 | 0.01 | 0.1 | 14 | 10.5 |
| 17 | 0.02 | 0.3 | 0.25 | | 0.4 | 0.01 | 0.1 | 14 | 10.5 |
| 18 | 0.02 | 0.3 | 0.1 | | 0.4 | 0.01 | 0.1 | 14 | 10.5 |
| 19 | 0.02 | 0.3 | | 0.4 | 0.4 | 0.01 | 0.1 | 14 | 10.5 |

TABLE 12

| | Ru RR |
|---|---|
| Slurries | (Å/min.) |
| 16 | 333 |
| 17 | 186 |
| 18 | 154 |
| 19 | 100 |

The polishing data in Table 12 indicate that ruthenium removal rates increase with increasing periodic acid concentrations. Hydrogen peroxide (H₂O₂) was a less effective oxidizer than periodic acid.

In summary, using periodic acid in high pH polishing slurries can yield higher ruthenium removal rates. By selecting a surfactant or polymer that contains either an ethylene oxide group (—CH₂—CH₂—O—), or an amide group

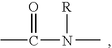

can further reduce low-k and ultra-low k dielectric removal rates. These polishing slurries with lower dielectric removal rates can remove both ruthenium layers and barrier layers, such as, tantalum and tantalum nitride. In addition, through the use of additives, it is possible to further adjust copper, TEOS and dielectric removal rates to satisfy various integration scheme's requirements.

1. A polishing slurry useful for removing ruthenium layers from patterned semiconductor substrates in the presence of at least one nonferrous interconnect metal and a dielectric comprising: 0.001 to 10 weight percent periodic acid or salt, at least 0.0001 weight percent inhibitor for reducing removal rate of the nonferrous interconnect metals, 0.00001 to 5 weight percent organic additive for reducing dielectric removal rate, the organic additive being selected from at least one of water soluble polymers and surfactants, the organic additive containing an ethylene oxide group or an amide group, 0.1 to 50 weight percent abrasive and balance water; and the slurry having a pH of greater than 8 to 12.

2. The polishing slurry of claim 1 wherein the organic additive includes the water soluble polymer.

3. The polishing slurry of claim 1 wherein the organic additive includes the surfactant; and the surfactant includes multiple ethylene oxide groups.

4. The polishing slurry of claim 1 wherein the organic additive includes the surfactant; and the surfactant includes an amide group.

5. A polishing slurry useful for removing ruthenium layers from patterned semiconductor substrates in the presence of at least one nonferrous interconnect metal and a dielectric comprising: 0.005 to 5 weight percent periodic acid or salt, at least 0.001 weight percent inhibitor for reducing removal rate of the nonferrous interconnect metals, 0.0001 to 2 weight percent organic additive for reducing dielectric removal rate, the organic additive being selected from at least one of water soluble polymers and surfactants, the organic additive containing an ethylene oxide group or an amide group, 0.2 to 40 weight percent abrasive and balance water; and the slurry having a pH of 8.2 to 11.

6. The polishing slurry of claim 5 wherein the organic additive includes the water soluble polymer and the water soluble polymer is selected from at least one of polyvinylpyrrolidone, poly(ethylene oxide), poly(ethylene glycol), poly(ethylene glycol)acrylate, poly(ethylene glycol)n-alkyl 3 sulfopropyl ether, poly(ethylene glycol)behenyl ether methacrylate, poly(ethylene glycol)-co-4 benzyloxybenzyl alcohol, poly(ethylene glycol)bis(3-aminopropyl) terminated, poly(ethylene glycol)bis(carboxymethyl)ether, poly(ethylene glycol)bis(2-ethylhexanoate), Poly(ethylene glycol)butyl ether, poly(ethylene glycol)diacrylate, poly(ethylene glycol)dibenzoate, poly(ethylene glycol)dimethyl ether, poly(ethylene glycol)methyl ether, poly(ethylene glycol)dimethyl ether methacrylate, poly(ethylene glycol)dioleate, poly(ethylene glycol)monooleate, poly(ethylene glycol)phenyl ether acrylate, poly(ethylene glycol)4-nonylphenyl 3-sulfopropyl ether, poly(ethylene glycol)divinyl ether, poly(propylene glycol), dimethylsiloxane/ethylene oxide copolymers, poly(ethylene glycol-block-propylene glycol), poly(ethylene glycol-block-propylene glycol-block-ethylene glycol), poly(ethylene glycol)tetrahydrofurfuryl ether, polyvinyl alcohol, poly(vinyl alcohol-co-ethylene), poly(ethylene adipate), polyacrylamide, poly(acrylamide-co-acrylic acid), poly(acrylamide-co-diallyldimethylammonium chloride), poly(2-acrylamido-2-methyl-1-propanesulfonic acid), poly(2-acrylamido-2-methyl-1-propanesulfonic acid-co-acrylonitrile), poly(2-acrylamido-2-methyl-1-propanesulfonic acid-co-styrene), poly(1-vinylpyrrolidone-co-2-dimethylaminoethyl methacrylate), polyvinylpyrrolidone-iodine complex, poly(1-vinylpyrrolidone-co-styrene), poly(1-vinylpyrrolidone-co-vinyl acetate) and derivatives of the foregoing.

7. The polishing slurry of claim 5 wherein the organic additive includes the surfactant; and
the surfactant is selected from at least one of: fatty alcohol polyglycol ether sulfate, ethoxylated fatty alcohol, ethoxylated alcohol phosphate ester, laureth sulfate salt, polyethyleneglycol ether, poly(ethylene glycol)laurate, poly(ethylene glycol)cocoamine, polyoxyethylene oleyl amine, polyethyleneglycol amine of hydrogenated tallow, non-ionic polyoxyethylene, polyoxypropylene block polymers, non-ionic ethoxylated alkyl phenols and derivatives of the foregoing.

8. The polishing slurry of claim 5 wherein the organic additive includes the surfactant; and the surfactant is selected from at least one of ethanolamides of coconut acid, fatty alcohol alkanolamide, cocoamide, coconut acid monoethanolamide, N,N-bis(2-hydroxyethyl) dodecanamide, polyoxyalkylene amide ester, alkyl amide propyl dimethyl glycine, sulfated fatty acid amide, amide ethoxylate, amide sulfonate, stearamide, polyolefin amide alkeneamine, oleic acid amide ethoxylate, alkylamide, polyalkoxylated amide, stearamidopropyl dimethylamine, polyisobutylenesuccinate amide, polyester amide, behenamidopropyl dimethylamine, lauroamidopropyl dimethylamine, distearyl phthalic acid amide, behenic acid amide, behenic acid diethanolamineamide, behenic acid monoethanolamineamide and derivatives of the foregoing.

9. A method of polishing a patterned semiconductor substrate, the patterned semiconductor substrate including a ruthenium layer in the presence of at least one nonferrous interconnect metal and a dielectric including the step of:
polishing the patterned semiconductor substrate with a polishing slurry and a polishing pad to remove at least a portion of the ruthenium layer, the polishing slurry comprising: 0.001 to 10 weight percent periodic acid or salt, at least 0.0001 weight percent inhibitor for reducing removal rate of the nonferrous interconnect metals, 0.00001 to 5 weight percent organic additive for reducing dielectric removal rate, the organic additive being selected from at least one of water soluble polymers and surfactants, the organic additive containing an ethylene oxide group or an amide group, 0.1 to 50 weight percent abrasive and balance water; and the slurry having a pH of greater than 8 to 12.

10. The method of claim 9 wherein the polishing removes ruthenium at a rate (Å/min.) greater than or equal to fifty percent of the dielectric removal rate (Å/min.) at a polishing pad downforce less than 25 kPa.
